(19) United States
(12) Patent Application Publication
(10) Pub. No.: US 2013/0050483 A1
(43) Pub. Date: Feb. 28, 2013

(54) APPARATUS, METHOD, AND PROGRAM FOR VIDEO SURVEILLANCE SYSTEM

(71) Applicants: Masaya Itoh, Hitachinaka (JP); Yuan Li, Hitachi (JP); Katsuhiko Kawamori, Nagareyama (JP); Tetsuo Nagano, Hitachinaka (JP)

(72) Inventors: Masaya Itoh, Hitachinaka (JP); Yuan Li, Hitachi (JP); Katsuhiko Kawamori, Nagareyama (JP); Tetsuo Nagano, Hitachinaka (JP)

(73) Assignee: Hitachi, Ltd.

(21) Appl. No.: 13/570,678

(22) Filed: Aug. 9, 2012

(30) Foreign Application Priority Data
Aug. 30, 2011 (JP) 2011-187044

(51) Int. Cl. H04N 7/18

(52) U.S. Cl. 348/143; 348/E07.085

(57) ABSTRACT

Recognition rate performance is prevented from dropping in executing image recognition processing on a moving object passing a surveillance area. A video surveillance apparatus includes a preprocessing information generating section that obtains position of a recognition processing region to be an object of image recognition processing and installation position of a camera, computes the positional relationship between the position of the recognition processing region and the installation position of the camera, and computes preprocessing information representing the positional relationship, a recognition parameter computation section for computing recognition parameters (coordinates of the recognition processing region in camera image) used for image recognition processing, based on the ratio between an actual value and a distance in an image captured by the camera with reference to the preprocessing information, and an image recognition processing section for executing image recognition processing on a surveillance object passing the recognition processing region, using the recognition parameters.

### CROSS REFERENCE TO RELATED APPLICATION

This application claims the priority of Japanese Patent Application No. 2011-187044, filed on Aug. 30, 2011, the entire specification, claims and drawings of which are incorporated herewith by reference.

### BACKGROUND OF THE INVENTION

1. Field of the Invention

The present invention relates to a technique for surveillance of a moving object passing a surveillance area by executing image recognizing processing on the moving object.

2. Description of the Related Art

In recent years, accompanying a growing interest in security, video surveillance systems in integration of access control and video surveillance have been introduced to buildings and offices. The number of network cameras tends to increase accompanying an increase in the number of surveillance areas for a video surveillance system, and the capacity of a video image recording device has become large. On the other hand, for a surveillance person who uses a video surveillance system, visual extracting of a specific scene from a recorded video image in a large data volume is a significantly heavy load. In this situation, discussion is developed on a video surveillance system having a function to support surveillance work.

For example, in order to reduce a load on a conventional visual work, video surveillance systems have been developed, wherein the video surveillance systems are provided with a video surveillance system having a function to detect moving objects such as a person, a vehicle, or the like, by performing image recognizing processing on a video image obtained by a camera, a function to record only scenes in which moving objects have been detected, a function to prompt attention by a surveillance person by displaying a warning on a display device, sounding an alarm, or the like. For example, disclosed is an access control device (a device that controls entering and leaving, a room, of persons) that detects the face of a person who passes a door by recognizing an image, and estimates the number of persons who entered or left a room by the number of detected faces (see Patent Literature 1: JP 2008-40828 A).

### SUMMARY OF THE INVENTION

However, in the technique disclosed by Patent Literature 1, in satisfying a requirement for capturing the image of a face by a camera, the recognition rate performance may be caused to vary, depending on the positional relationship between the installation position of the camera and the position of a target object. For example, in case that the camera is installed in a direction of viewing down from above in capturing the image of a face, it is difficult to detect the face, and the recognition rate performance may drop. Further, due to restriction of the installation position of the camera, it is also possible that the camera cannot be installed at a position where the recognition rate performance is at the highest.

In this situation, the invention provides a technique for preventing the recognition rate performance from dropping in executing image recognition processing on a moving object that passes a surveillance area.

In order to solve the above-described problems, according to the present invention, a video surveillance apparatus includes a section, for preprocessing for performing image recognition processing, that obtains position of a recognition processing region to be an object of image recognition processing and installation position of a camera, computes the positional relationship between the position of the recognition processing region and the installation position of the camera, and computes preprocessing information representing the positional relationship, a section for computing recognition parameters (coordinates of the recognition processing region in camera image) used for image recognition processing, based on the ratio between an actual value and a distance in an image captured by the camera with reference to the preprocessing information, and a section for executing image recognition processing on a surveillance object passing the recognition processing region, using the recognition parameters.

According to the invention, it is possible to prevent the recognition rate performance from dropping in executing image recognition processing on a moving object that passes a surveillance area.

### BRIEF DESCRIPTION OF THE DRAWINGS

FIG. 1 is a diagram showing an example of the configuration of a video surveillance system and an example of a function of a video surveillance apparatus according to the present invention;

FIG. 2 is a diagram showing an example of information on a surveillance area;

FIG. 3 is a diagram showing an example of a screen displaying layout information;

FIG. 4 is a diagram showing an example of camera information;

FIG. 5 is a diagram illustrating a positional relationship between the installation position of a camera and a recognition processing region;

FIG. 6 is a diagram illustrating a relationship between a distance in a camera image and an actual measurement value;

FIG. 7 is a diagram showing an example of setting a two dimensional recognition processing region in a camera image;

FIGS. 8A and 8B are diagrams showing examples of transforming recognition parameters used for image recognition processing, wherein FIG. 8A shows a case of transforming a template to make the template match with a camera position, and FIG. 8B shows a case of transforming a camera image to make a camera image match with the image capturing direction of the template;

FIG. 9 is a diagram showing an example of a screen that displays layout information for setting a three dimensional recognition processing region in a camera image;

FIG. 10 is a diagram showing an example of setting the three dimensional recognition processing region in a camera image; and

FIG. 11 is a diagram showing, as a modified example, an example of a screen that displays layout information that enables selection of a camera installation position having been set in advance.

### DETAILED DESCRIPTION OF THE PREFERRED EMBODIMENTS

Embodiment for carrying out the present invention will be described below in detail, referring to the drawings, as appropriate.

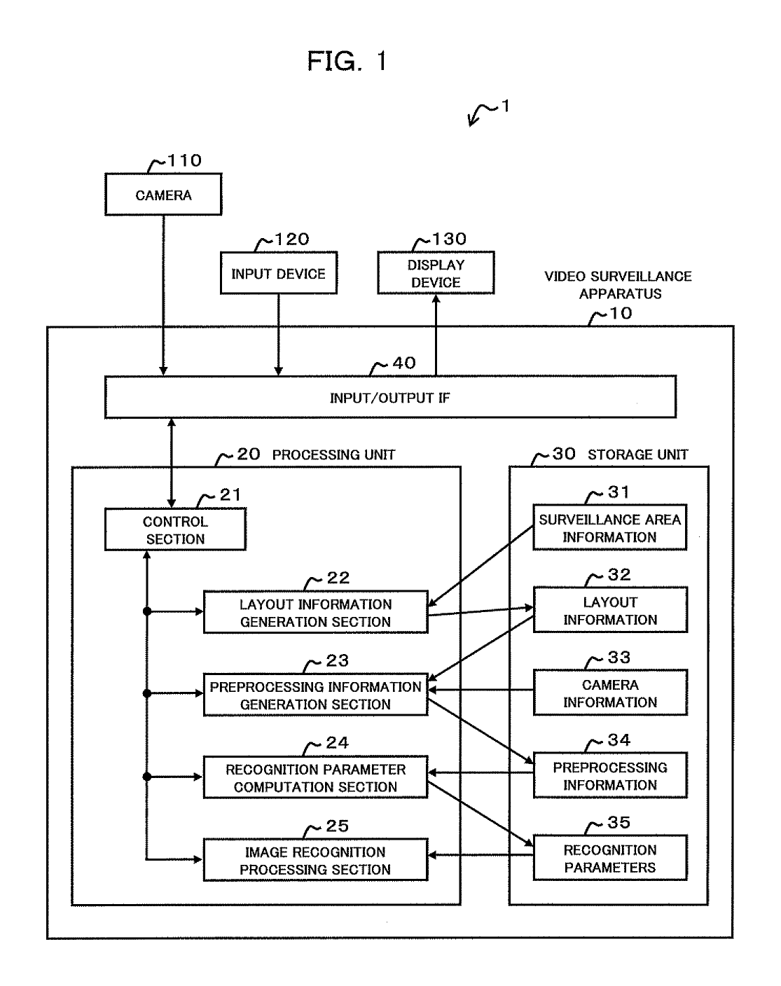

An example of configuration of a video surveillance system and examples of functions of a surveillance apparatus in the present embodiment will be described below with reference to FIG. 1.

A video surveillance system 1 is configured with a camera 110, an input device 120, a display device 130, and a video surveillance apparatus 10. In the present embodiment, it is assumed that the video surveillance apparatus 10 has a function to surveil a moving object, such as a person or vehicle, by image recognition processing.

The camera 110 is an image capturing apparatus including a camera lens unit having a zoom function and an image capturing device such as a CMOS (Complementary Metal Oxide Semiconductor), a CCD (Charge Coupled Device), or the like. Further, the camera 110 is installed on a pan head (not shown) and is rotatable by tilting or panning. The camera 110 has a function to transmit captured image information to the video surveillance apparatus 10. Although only one camera 110 is shown in FIG. 1, plural cameras may be provided.

The input device 120 is a pointing device (mouse, etc.), a keyboard, or the like and has a function to input instruction information to the video surveillance apparatus 10 by a user operation.

The display device 130 is a flat panel display, a CRT (Cathode Ray Tube) display, an RGB (Red-Green-Blue) monitor, or the like, and has a function to display output information from the video surveillance apparatus 10. Although only one display device 130 is shown in FIG. 1, plural display devices may be provided.

The video surveillance apparatus 10 is provided with a processing unit 20, a storage unit 30, and an input/output IF (Interface) 40. The processing unit 20 includes a control section 21, a layout information generation section 22, a preprocessing information generation section 23, a recognition parameter computation section 24, and an image recognition processing section 25. The processing unit 20 is configured with a CPU (Central Processing Unit), not shown, and a main memory, and the respective sections of the processing unit 20 load an application program stored in the storage unit 30 into the main memory to execute the application program.

The storage unit 30 stores surveillance area information 31, layout information 32, camera information 33, preprocessing information 34, and recognition parameters 35. The details of the respective information stored in the storage unit 30 will be described later in the description of the respective sections of the processing unit 20.

The input/output IF 40 is an interface for transmitting and receiving information between the camera 110, input device 120, the display device 130, and the processing unit 20 of the video surveillance apparatus 10.

The control section 21 has a function to integrally control operations between the layout information generation section 22, the preprocessing information generation section 23, the recognition parameter computation section 24, and the image recognition processing section 25, a function to transmit/receive information between the camera 110, the input device 120, and the display device 130 via the input/output IF 40, and a function to transmit/receive information between the respective sections in the processing unit 20 and between the respective sections in the processing unit 20 and the storage unit 30.

The layout information generation section 22 obtains surveillance area information 31 including a plan view, a room layout view, and the like of a place to install the camera 110, and generates layout information 32 necessary for setting a recognition processing region suitable for a surveillance object. Herein, a surveillance object refers to the whole or a part of a moving object to be an object of image recognition processing. Concretely, when a moving object is a person, the whole of the moving object refers to the whole body of the person, and a part of the moving object refers to a part of the body (for example, the face or the head). A recognition processing region refers to an image region to be used for image recognition processing on image information (hereinafter, referred to as a camera image) captured by the camera 110 in performing image recognition processing on a surveillance object. Both the surveillance area information 31 and the layout information 32 are stored in the storage unit 30.

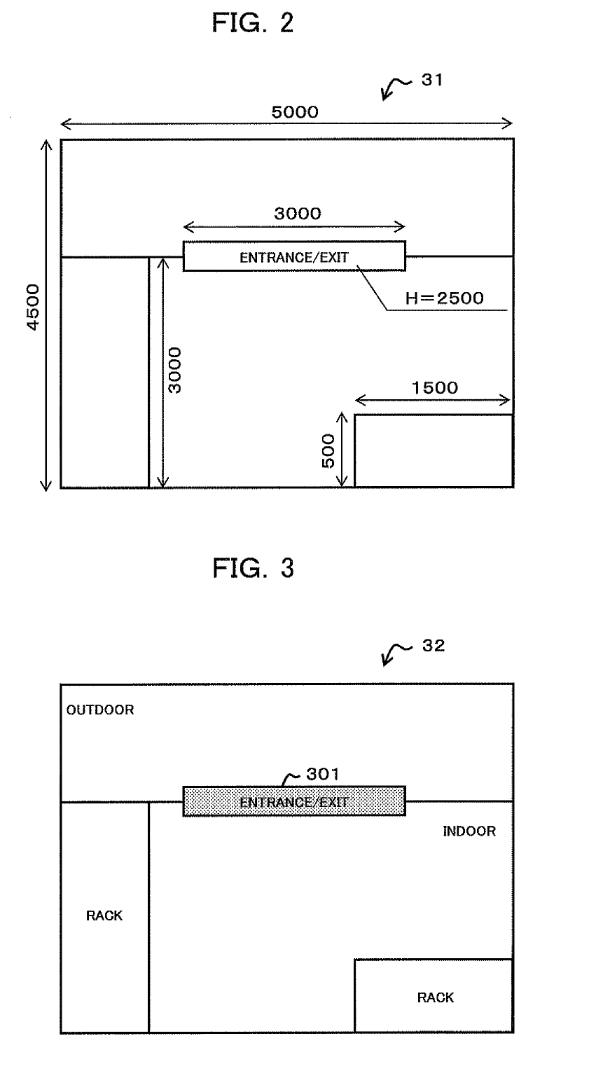

Herein, concrete examples of the surveillance area information 31 and the layout information 32 will be described with reference to FIGS. 2 and 3.

The surveillance area information 31 is a plan view (room layout view), as shown in FIG. 2, in which information on the dimensions of main parts are described. For example, a horizontal actual measurement value (in unit of mm) of the entrance/exit is described. The surveillance area information 31 may be three dimensional CAD (Computer Aided Design) data or CG (Computer Graphics) data.

As shown in FIG. 3, the layout information 32 is generated by extracting information necessary for setting a recognition processing region from the surveillance area information 31. In the present embodiment, a case that a moving object passing an entrance/exit 301 is a surveillance object will be described below, and the entrance/exit 301 will accordingly be displayed with shading as a recognition processing region. Alternatively, only the recognition processing region (entrance/exit 301) may be displayed because the purpose of generating the layout information 32 is to obtain the positional relationship between the recognition processing region and the installation position of the camera 110. Further, in case of performing access control, which side is outdoor and which side is indoor (related to the direction a moving object moves) with respect to the recognition processing region (entrance/exit 301) becomes important information, and this information is better be included.

Returning to FIG. 1, the preprocessing information generation section 23 generates the preprocessing information 34, using the layout information 32 and the camera information 33.

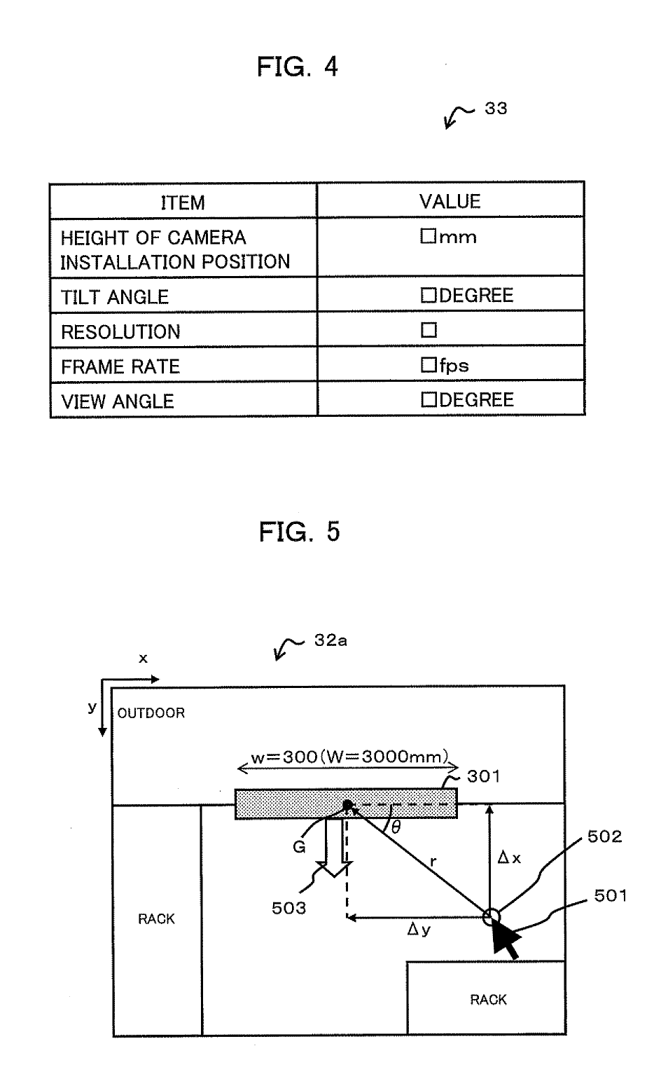

As shown in FIG. 4, the camera information 33 includes the height of the camera installation position, the tilt angle, the resolution, the frame rate, and the angle of view. The preprocessing information 34 includes the angle, the horizontal distance, and the height indicating the installation position of the camera 110 with respect to the recognition processing region (entrance/exit 301), and actual measurement values of the recognition processing region. As the actual measurement values of the recognition processing region can be obtained from the layout information 32 and the height can be obtained from the camera information 33, a method for computing the angle and the horizontal distance of the preprocessing information 34 will be described below as the processing by the preprocessing information generation section 23.

First, as shown in FIG. 5, the preprocessing information generation section 23 displays the layout information 32 (see FIG. 3) generated by the layout information generation section 22 on the display device 130, as shown as layout information 32a. On the layout information 32a, the recognition processing region (entrance/exit 301) is displayed. Then, the preprocessing information generation section 23 receives input of the installation position of the camera 110 from the input device 120 operated by a user. Concretely, in FIG. 5, a position designated by a cursor 501 becomes the camera installation position 502 indicating the installation position of the camera 110.

Then, the preprocessing information generation section 23 computes a distance r between the recognition processing region (entrance/exit 301) and the camera installation position 502 and an angle θ from the positional relationship on the layout information 32a shown in FIG. 5. Concretely, as the actual measurement value of the width of the recognition processing region (entrance/exit 301) is known, actual measurement values of various lengths on the layout information 32a can be easily estimated by using the ratio of the actual measurement value of the width of the recognition processing region (entrance/exit 301) to the display size of the recognition processing region (entrance/exit 301) on the layout information 32a. This procedure is an essential part of the present embodiment, wherein the positional relationship between the recognition processing region (entrance/exit 301) and the camera installation position 502 can be easily obtained from the positional relationship on the layout information 32a, without performing actual measurement. In the present embodiment, for distinction, actual measurement values will be represented by an upper case letter (for example, distance R, height H, Ho, etc.), while lengths on the layout information 32 or a camera image will be represented by a lower case letter (for example, distance r, height h, ho, etc.).

Method for obtaining the distance r between the camera installation position 502 and the center G of the recognition processing region (entrance/exit 301) will be described below. The direction (the direction of the optical axis of the lens) of the camera 110 is assumed to face the center G.

For definition of a distance on the layout information 32a in FIG. 5, for example, X axis is set in the horizontal direction and Y axis is set in the vertical direction with the left top of the layout information 32a as the origin. The preprocessing information generation section 23 obtains the actual measurement value (W=3000 mm) in x axis direction of the recognition processing region (entrance/exit 301) from the layout information 32a and obtains the width w (for example, 300 pixels) on the layout information 32a. Further, the preprocessing information generation section 23 obtains Δx (for example, 150 pixels) and Δy (for example, 200 pixels) from the layout information 32a. The actual measurement values ΔX and ΔY (in unit of mm) are obtained as follows.

w:Δy=300:200=W:ΔY=3000:ΔY

Δy:Δx=200:150=ΔY:ΔX

Therefore, ΔY=2000 (mm), ΔX=1500 (mm).

Using ΔX and ΔY obtained by the above calculation, the horizontal distance R between the center G of the recognition processing region (entrance/exit 301) and the camera installation position 502 and the angle θ are computed by Expression (1).

R=(ΔX²+ΔY²)^{1/2}

θ=arcos (ΔX/R) Expression (1)

The preprocessing information generation section 23 stores the horizontal distance R, the angle θ computed by Expression (1) through such a procedure, the height H of the entrance/exit 301, and the actual measurement values of the recognition processing region, in the storage unit 30.

Then, returning to FIG. 1, the recognition parameter computation section 24 generates recognition parameters 35 with reference to the preprocessing information 34 and stores the recognition parameters 35 in the storage unit 30. The recognition parameters 35 concretely refers to the coordinates of the recognition processing region in a camera image, the moving direction of a surveillance object in the camera image, and transformation information (a transformation expression or a transformation table) on a template (including model information obtained by a training algorithm), which will be used in executing image recognition processing. Methods for computing the coordinates of the recognition processing region in the camera image, the moving direction of a surveillance object in the camera image, and the transformation information on the template will be respectively described below,

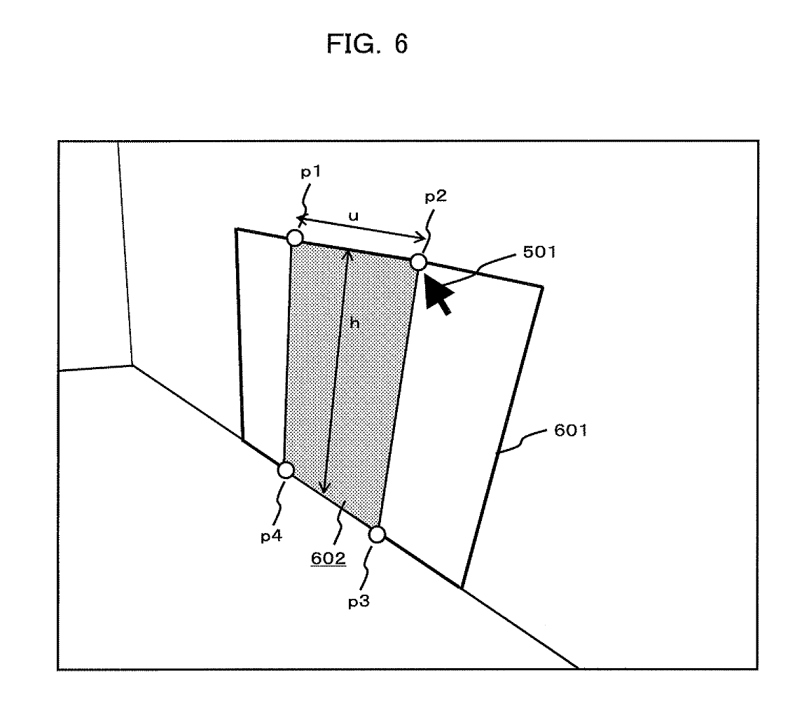

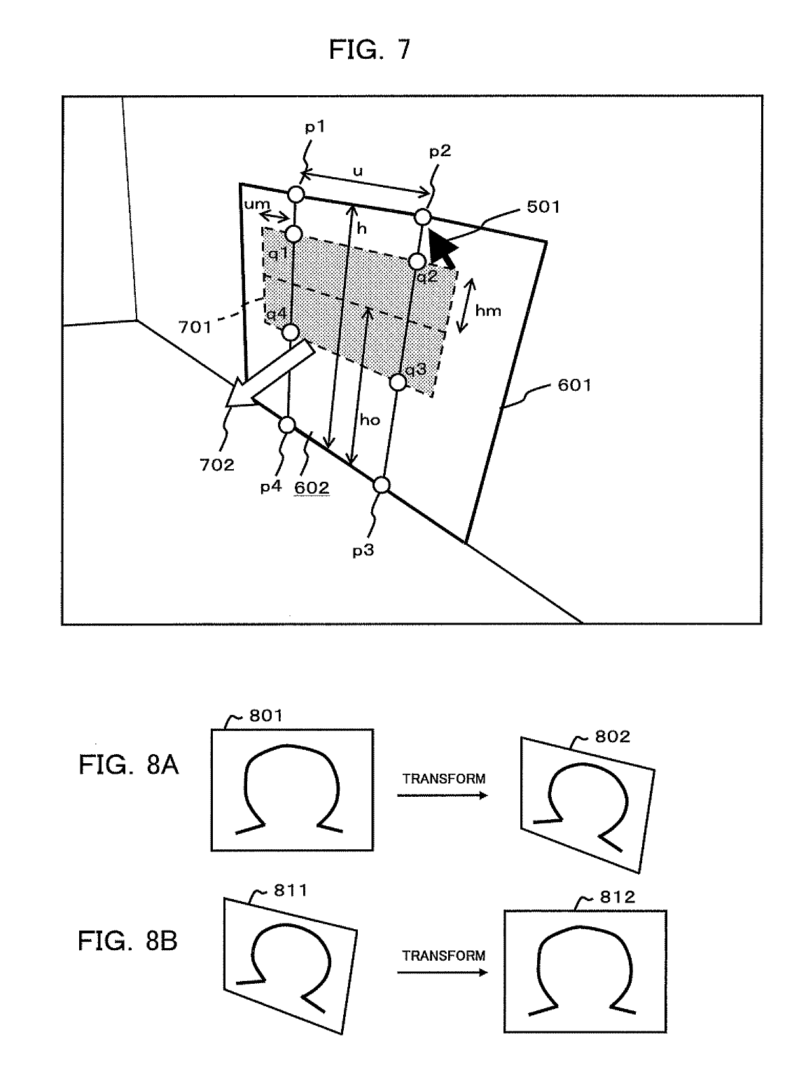

First, the relationship between the distance in a camera image and the actual measurement values will be described below with reference to FIG. 6. Then, with reference to FIG. 7, a method for setting the recognition processing region in the camera image will be described, based on the relationship between the actual measured value and the distance in the camera image. The reason for the necessity of the relationship between the distance in a camera image and the actual measured values is that the size of the recognition processing region in a camera image is determined, based on actual measurement values in a real space. For example, in case that a surveillance object is the face of a person, the area where the face of the person is positioned is determined, based on the distribution of the actual measurement values of the heights of persons, and the region in a camera image corresponding to the area is determined as the recognition processing region. By narrowing the recognition processing region in such a manner, the computation processing amount can be reduced, compared with a case of executing image recognition processing over the whole camera image, which causes an advantage of the video surveillance apparatus 10.

FIG. 6 shows a camera image (captured image) captured by the camera 110 and displayed on the display device 130. The entrance/exit 301 in FIG. 5 is displayed as an entrance/exit 601 in this camera image.

Upon reception of the positions of four points (p1 to p4) representing the corner points of a region 602 in the area showing the entrance/exit 601, the four points being designated (for example, by click operation in a case of a mouse) using the cursor 501 operated via the input device 120, the recognition parameter computation section 24 obtains the coordinates of the designated points (point p1 to point p4). The points p1 and p2 are designated at the upper end of the entrance/exit 601, and the points p3 and p4 are designated at the lower end of the entrance/exit 601. The values of the coordinates of the points p1 to p4 obtained here may be the coordinate values of an image coordinate system for which X axis is defined in the horizontal direction and Y axis is defined in the horizontal direction with the left top of the camera image as the origin. In FIG. 6, although the region 602 is displayed with shading for a clear appearance, shading may be displayed in a screen on an actual display device 130.

Herein, the size of the region 602 is obtained by using that the width w of the recognition processing region (entrance/exit 301) of the layout information 32a in FIG. 5 is represented by the width of the entrance/exit 601 in the camera image. That is, the actual measurement value of the width u in the camera image can be computed by multiplying the ratio between the width u and the width of the entrance/exit 601, which are in the camera image, by the actual measurement value of the width w of the recognition processing region (entrance/exit 301) in the layout information 32a in FIG. 5. Further, the actual measured value of the height h in the camera image is the actual measurement value of the height H of the entrance/exit 301 in FIG. 5.

An example of a case of setting the recognition processing region to the head of a person is applied to a surveillance object will be described with reference to FIG. 7.

In FIG. 7, the region 602 enclosed by the four points p1 to p4 is the same as one shown in FIG. 6. That is, the actual measurement values of the height h and the width u of the region 602 are known. Accordingly, the height of the head is obtained from the height of an actual person to determine the height Ho. In the camera image shown in FIG. 7, the position of the height ho can be set in the camera image, based on the ratio between the height Ho of the head of the person and the height H of the entrance/exit 301. The region with respect to the height direction where the head of a person is assumed to pass can be set by setting a margin Hm (hm in the camera image) of height as represented by the points q1 to q4.

Further, with respect to the width direction, the margin um of the width in the camera image can be obtained from the margin Um of the actual width, based on the ratio between the width u in the camera image and a corresponding actual measurement value. The recognition parameter computation section 24 can set a recognition processing region 701 (shading display) in a case of making the head of a person a be surveillance object. By such a procedure, the recognition parameter computation section 24 can compute the coordinates (possibly the coordinates of the corner points) of the recognition processing region 701 in the camera image.

Then, the moving direction of a surveillance object in the camera image will be described with reference to FIGS. 5 and 7. For example, in a case of counting the number of moving objects, the moving direction of a surveillance object in a camera image is necessary for determination whether a moving object has come in through the entrance/exit or has gone out. Further, in case of performing access control of persons, the moving direction of a surveillance object in a camera image is necessary for determination whether a person has entered or left the room.

On the layout information 32 in FIG. 5, an arrow 503 is displayed in a direction where a surveillance object comes in from the entrance/exit 301 into the room. The arrow 503 is assumed to be perpendicular to the entrance/exit 301. If the arrow 503 is displayed in the camera image shown in FIG. 7, an arrow 702 is obtained in a direction perpendicular to the recognition processing region 701. As a qualitative description, as the angle θ shown in FIG. 5 becomes closer to zero degree, the arrow 702 in FIG. 7 becomes horizontal in the camera image, and as the angle θ becomes closer to 90 degrees, the arrow 702 becomes vertical in the camera image. The recognition parameter computation section 24 can compute the moving direction of a surveillance object in the camera image. Herein, in case of performing access control of persons, when various movements (moving directions) have been detected by the image recognition processing section 25, the computed moving direction (arrow 702) can also be used as an index for sorting whether to handle the movement to be used for determination of entering or leaving of a person into/from the room or to handle the movement as a noise (not to be used for determination).

A method for using the moving direction (arrow 702) of a surveillance object in a camera image will be described below. In the case of the layout information 32a in FIG. 5, when the movement of a surveillance object has been detected in image recognition processing, if the movement is in a range with an angle smaller than the right angle with respect to the arrow 702, the movement is determined to be an action of entering the room, and if the movement is in a range with an angle larger than the right angle with respect to the arrow 702, the movement is determined to be an action of leaving the room.

Computation of the transfer information on a template will be described below with reference to FIGS. 8A and 8B. FIG. 8A shows a case of transforming a template to make the template match with the camera position, and FIG. 8B shows a case of transforming a camera image to adjust the direction of the camera image to the image capturing direction of the template.

For example, in FIG. 8A, if a template 801 whose image having been captured from the front is prepared, in case of the layout information 32a shown in FIG. 5, as a surveillance object in a camera image is subjected to image capturing from the position at the height of the camera installation position 502 and the angle θ, the pattern of the surveillance object differs from the pattern of the template. Accordingly, the recognition parameter computation section 24 executes transformation processing on the template as if the image of the template were captured from the position and the angle of the camera installation position 502, and thereby generates a template 802 after the transformation. The transfer information is determined, based on the height and the angle θ of the camera installation position 502. Then, the image recognition processing section 25 executes image recognition processing, using the template 802 after the transformation, and a drop in the recognition rate performance can thereby be prevented.

In FIG. 8B, the image of the surveillance object appearing in the camera image is captured from the height and the angle θ of the camera installation position 502 as the image information 811. In this situation, in case that the template 801 whose image has been captured from the front is prepared, the recognition parameter computation section 24 executed processing to transform the image information 811 into a state of image capturing from the front, and thus generates image information 812 after the transformation. The transformation information is determined, based on the height and the angle θ of the camera installation position 502. Then, the image recognition processing section 25 executes image recognition processing, using the image information 812 after the transformation, and a drop in the recognition rate performance can thereby be prevented.

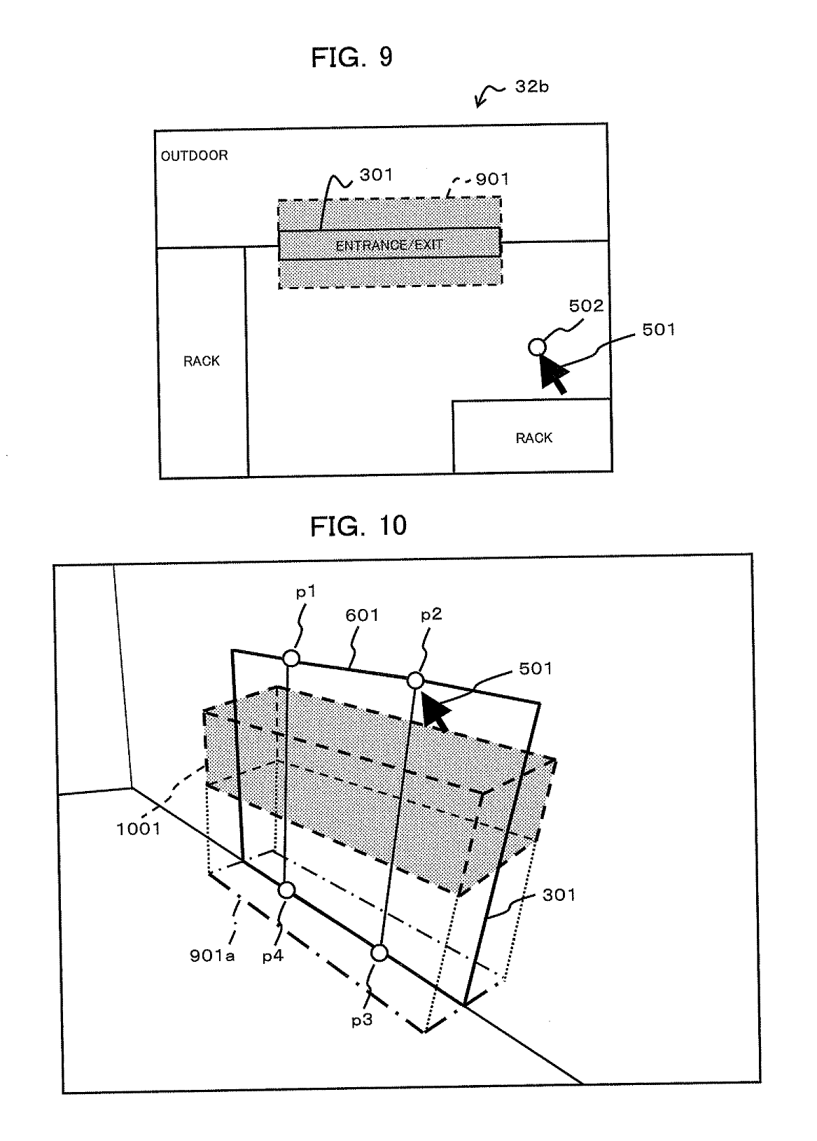

A case of setting a three dimensional recognition processing region in a camera image will be described with reference to FIGS. 9 and 10.

FIG. 9 shows an example of layout information 32b designating a recognition processing region 901 (shaded display) in the periphery of the entrance/exit 301. The layout information 32b is generated by the layout information generation section 22. The recognition processing region 901 (shaded display) is set by that the layout information generation section 22 receives an input of the corner points of the surveillance area 901 designated by the cursor 501. Then, the coordinates of the recognition processing region 901 (shaded display) of the layout information 32b are stored in the preprocessing information 34 by the preprocessing information generation section 23.

Then, the recognition parameter computation section 24 first sets the recognition processing region 901 as a recognition processing region 901a (alternate long and short dash lines)in the camera image shown in FIG. 10. The size of the recognition processing region 901a is set, based on the vertical/horizontal ratio of the recognition processing region 901 displayed in the layout information 32b shown in FIG. 9. The depth direction with respect to the width of the recognition processing region 901a is determined such as to be parallel with the direction that is perpendicular to the plane formed by the points p1 to p4.

Then, the recognition parameter computation section 24 sets height positions with respect to the corner points of the recognition processing region 901a similarly to that the two dimensional recognition processing region 701 has been set in FIG. 7, and can thereby set a three dimensional recognition processing region 1001 (shaded display).

Returning to FIG. 1, the image recognition processing section 25 executes image recognition processing on a surveillance object passing the recognition processing region 701 (shaded display) in FIG. 7 or the recognition processing region 1001 (shaded display) in FIG. 10, referring to the recognition parameters stored in the storage section 30, and outputs a processing result to the display device 130. As mage recognition processing, a known art (Ejima, ‘A Robust Human Motion Tracking System Using HeadFinder’ The Institute of Electronics, Information and Communication Engineers (IEICE), Technical Research Report. PRMU, Pattern Recognition/Media Understanding 100 (442), 15-22, 2000 Nov. 9) can be used.

### MODIFIED EXAMPLE

In the present embodiment, a case that the camera installation position 502 is set at an arbitrary place has been described. A modified example will be described below in a case that selectable camera installation positions 502 are prepared in a plural number in advance, recognition parameters are computed for the respective camera installation positions 502 in advance and the camera installation positions 502 and the recognition parameters are associated with each other and stored in the storage unit 30.

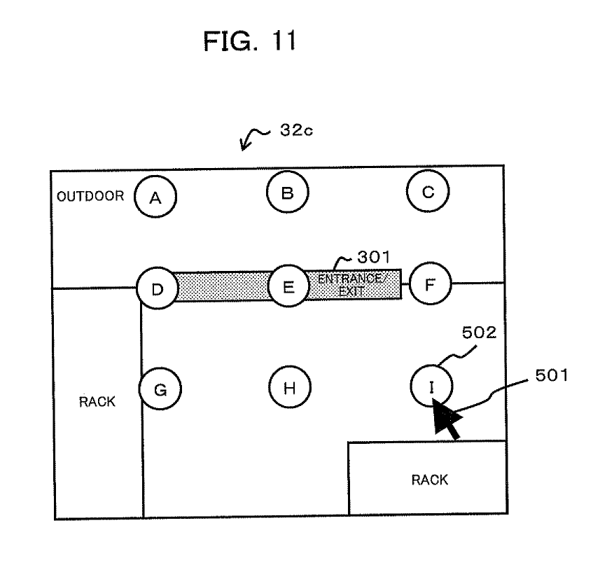

FIG. 11 shows an example of layout information 32c displaying camera installation positions 502 (A to I) determined in advance and a recognition processing region (entrance/exit 301). In FIG. 11, the control section 21 receives an input for which one of the camera setting positions 502 (A to I) has been selected using the cursor 501 via the input device 120. Then, the image recognition processing section 25 obtains, from the storage unit 30, recognition parameters 35 corresponding to the camera installation position 502 (A to I) with which the image recognition processing section 25 has received the input, and executes image recognition processing. With such an arrangement, as inner computation for generating the recognition parameters 35 can be omitted, it is possible to shorten the time for generating recognition parameters 35 to be used before a start of image recognition processing.

As has been described above, the video surveillance apparatus 10 in the present embodiment includes a preprocessing information generation section 23 that obtains the position of a recognition processing region 301 to be an object of image recognition processing and a camera installation position 502, computes the positional relationship between the position of the recognition processing region 301 and the camera installation position 502, and computes preprocessing information 34 representing the positional relationship, a recognition parameter computation section 24 that computes recognition parameters 35 (coordinates of a recognition processing region 701 in a camera image) to be used for image recognition processing, based on the ratios between actual measurement values and distances in the camera image captured by the camera 110 and referring to the preprocessing information 34, and an image recognition processing section 25 that executes image recognition processing on a surveillance object passing the recognition processing region 701, using the recognition parameters 35.

Although, in the present embodiment, it has been described that the layout information generation section 22 generates layout information 32 from surveillance area information 31, a user may manually and directly create layout information 32 to attain the purpose.

Further, although, in FIG. 6, the corner points of a region 602 are designated at four points, positions to be designated are not limited to four points, and a region may be expressed by three or more points.

What is claimed is:

1. A video surveillance apparatus for surveilling a moving object by obtaining a captured image from a camera for image-capturing of a moving object passing a surveillance area and executing image recognition processing on the obtained captured image, comprising:
a first means that, on a plane defined in a two dimensional space, obtains a position of a recognition processing region representing a region for executing the image recognition processing on the moving object in the captured image and an installation position of a camera for capturing the image of the moving object, and computes a positional relationship between the position of the recognition processing region and the installation position of the camera;
a second means for computing a position of the recognition processing region in the captured image used for the image recognition processing, based on the positional relationship, the computed position being in a form of a recognition parameter/parameters; and
a third means for executing the image recognition processing, using the recognition parameter/parameters.

2. The video surveillance apparatus according to claim 1, wherein the first means computes, as the positional relationship, an angle that is formed on the plane by a reference line passing a predetermined position in the recognition processing region and a line passing the predetermined point and a point representing a foot of a perpendicular line drawn from the installation position of the camera down to the plane, the camera being not on the plane to the plane.

3. The video surveillance apparatus according to claim 1, wherein the second means sets corner positions of the recognition processing region in the captured image, using a ratio between an actual measurement value of the recognition processing region in a real space and a distance of the recognition processing region in the captured image, and based on the actual measurement value.

4. The video surveillance apparatus according to claim 1, wherein the second means further computes, as the recognition parameter/parameters and based on the positional relationship, transformation information for transformation to cause an image of a template used for the image recognition processing and the captured image to become in a state of being captured from a same direction.

5. The video surveillance apparatus according to claim 1,
wherein the second means further computes, as the recognition parameter/parameters, a direction that is perpendicular to the recognition processing region in the captured image, and
wherein the third means determines movement of the moving object by comparison of a movement direction of the moving object obtained by the image recognition processing and the direction computed by the second means.

6. The video surveillance apparatus according to claim 2, wherein the first means obtains, from an input device operated by a user, a vertical height from the plane, a tilt angle of the camera with respect to the plane, and a direction of the camera as the installation position of the camera, the direction being parallel with the plane.

7. The video surveillance apparatus according to claim 1, further comprising:
a storage unit that stores plural installation positions of the camera, associating the installation positions of the camera and the recognition parameter/parameters in advance; and
a fourth means for receiving an input for selection of one of the plural install positions of the camera from an input device operated by a user,
wherein the third means obtains the recognition parameter/parameters associated with the installation position of the camera from the storage unit, the installation position having been received by the fourth means, and executes the image recognition processing, using the obtained recognition parameter/parameters.

8. A method for video surveillance for a video surveillance apparatus that surveils a moving object by obtaining a captured image from a camera for image-capturing of a moving object passing a surveillance area and executing image recognition processing on the obtained captured image, comprising:
a first step of, on a plane defined in a two dimensional space, obtaining a position of a recognition processing region representing a region for executing image recognition processing on the moving object in the captured image and an installation position of a camera for capturing the image of the moving object, and computing a positional relationship between the position of the recognition processing region and the installation position of the camera;
a second step of computing a position of the recognition processing region in the captured image used for the image recognition processing, based on the positional relationship, the computed position being in a form of a recognition parameter/parameters; and
a third step of executing the image recognition processing, using the recognition parameter/parameters.

9. The method for video surveillance according to claim 8,
wherein the first step obtains plural installation positions of the camera for capturing the image of the moving object, and computes positional relationships between the position of the recognition processing region and the respective installation positions of the camera;
wherein the second step further stores the plural installation positions of the camera and the respective recognition parameters in association with each other in advance;
wherein the third step further
receives an input for selection of one of the plural install positions of the camera via an input device operated by a user, obtains the recognition parameter/parameters stored in association with the installation position of the camera, the installation position having been selected, and executes the image recognition processing, using the recognition parameter/parameters.

10. A non-transitory computer readable for embodying a program for executing the video surveillance method according to claim 8 by the video surveillance apparatus that is a computer.
